(19) United States
(12) Patent Application Publication
(10) Pub. No.: US 2017/0104534 A1
(43) Pub. Date: Apr. 13, 2017

(54) SYSTEMS AND METHODS FOR TRANSMITTING DATA BETWEEN A REMOTE DEVICE AND A COMPUTING DEVICE

(71) Applicant: Performance Designed Products LLC, Burbank, CA (US)

(72) Inventor: Storm Orion, Valencia, CA (US)

(73) Assignee: Performance Designed Products LLC, Burbank, CA (US)

(21) Appl. No.: 15/292,061

(22) Filed: Oct. 12, 2016

Related U.S. Application Data
(60) Provisional application No. 62/240,420, filed on Oct. 12, 2015.

(51) Int. Cl. H04B 10/114; G06F 3/041; G06F 3/044

(52) U.S. Cl. CPC H04B 10/1143; G06F 3/044; G06F 3/0416; G06F 2203/0384; G06F 2203/0383

(57) ABSTRACT

A remote device configured to wirelessly communicate with a computing device without using RF signaling. Embodiments of the remote device may include a processor; a memory coupled to the processor and configured to store data; one or more transistor(s); and one or more output pad(s) operatively coupled with the one or more transistor(s). The processor is configured to cause the one or more transistor(s) to selectively ground one or more of the output pad(s). The one or more output pad(s) are configured to be selectively grounded to impose a capacitive load pattern on the capacitive sensor of a computing device, the capacitive load pattern encoding the data. The pattern is detectable and decodable by the computing device to recover the data. Embodiments of the remote device may include a photodetector to detect light pulses from the display of a computing device, the light pulses representing data from the computing device.

### PRIORITY INFORMATION

This application claims the benefit of and priority to U.S. Provisional Patent Application Ser. No. 62/240,420 filed on Oct. 12, 2015, the teachings of which are incorporated herein by reference.

### TECHNICAL FIELD

The present disclosure relates generally to transmitting data between two or more devices (e.g. a remote device and a computing device), and more particularly, some embodiments relate to transmitting data between a first device (e.g. a remote device) and a second device (e.g. a computing device) without use of a radio frequency.

### BACKGROUND

Transferring data between a two or more devices (e.g. remote device and a computing device) traditionally requires use of a radio frequency (e.g., Wi-Fi, Bluetooth, radio-frequency identification, etc.). Use of a radio frequency may also require that the devices include a particular radio capable of establishing the communication connection. Compatibility issues may arise when attempting to establish a connection between devices including different radios.

### SUMMARY

The disclosure herein relates to transmitting data between a remote device (sometimes referred to herein as a “first device”) and a computing device (sometimes referred to herein as a “second device”) without use of a radio frequency. Embodiments of the present disclosure may include a first device (e.g. a remote device) configured to communicate with a second device (e.g. a computing device), the first device including a processor; a memory coupled to the processor and configured to store a first device data; and/or a transistor having a base coupled to the processor, an emitter coupled to ground, and a carrier coupled to an output pad.

In some embodiments, the processor of the first device is configured to cause the transistor to selectively ground the output pad. The grounded output pad may be configured to impose a capacitive load on a capacitive sensor of a second device when brought within a sensing distance of the capacitive sensor. The output pad is configured to be selectively grounded (e.g. grounded multiple times responsive to the processors operation of the transistor) to impose a capacitive load on the capacitive sensor of the second device in accordance with a pattern (e.g. a temporal pattern, a spatial pattern, a spatiotemporal pattern, etc.). The capacitive load pattern may encode the first device data. In embodiments, the pattern is detectable by the second device via the capacitive sensor, and/or decodable by the second device to recover the first device data.

In some embodiments, the first device may include a photodetector configured to detect light pulses generated by the second device. The light pulses may encode a second device data stored in a memory of the second device. In some embodiments, the photodetector may be configured to transduce (or to effectuate transduction of) the light pulses into electrical pulses. The electrical pulses may be decodable by a processor of the second device to recover the second device data. In some instances the photodetector may be configured to detect light pulses generated by a light-emitting display screen of the second device. In some embodiments, the output pad and the photodetector may operate simultaneously such that first device data is transmitted by the first device while second device data is received by the first device.

In some implementations, the first device may include a light-emitting diode coupled to the processor and configured to emit light during a portion of a timeframe within which the output pad is being selectively grounded to impose a capacitive load on the capacitive sensor of the second device.

In still further embodiments, the first device may include a battery and a solar cell (coupled to the battery). The solar cell may be configured to convert light energy into electrical energy that can/may be stored in the battery.

In some implementations, output pad of the first device may impose a capacitive load on the capacitive sensor of the second device without physically contacting the capacitive sensor of the second device. The capacitive load imposed by the output pad on the capacitive sensor of the second device may be consistent with the capacitive load imposed by a human finger touching the capacitive sensor. In some implementations the capacitive sensor is embodied in a capacitive touchscreen display of the second device, the second device including one or more of a smart phone, a tablet, a PDA, and a palmtop.

Some embodiments of the first device (e.g. a remote device) in accordance with the present disclosure may include a processor; a memory coupled to the processor and configured to store a first device data; two or more transistor(s); and/or two or more output pad(s) operatively coupled with the two or more transistor(s). In some embodiments, the processor may be configured to cause the two or more transistor(s) to selectively ground two or more of the output pad(s). The grounded output pad(s) may be configured to impose a capacitive load on a capacitive sensor of a second device when brought within a sensing distance of the capacitive sensor. The two or more output pad(s) may be configured to be selectively grounded to impose a capacitive load pattern (e.g. a temporal pattern, a spatial pattern, and/or a spatiotemporal pattern) on the capacitive sensor of the second device. The capacitive load pattern may encode the first device data. In some embodiments, the capacitive load pattern is detectable by the second device via the capacitive sensor, and/or decodable by the second device to recover the first device data.

In some implementations, two or more of the output pad(s) may be configured to impose capacitive load(s) at different locations on the capacitive sensor of the second device. The two or more capacitive load(s) may be imposed by the two or more output pads simultaneously, or at different times, and/or in concert.

In some implementations, the first device may include a photodetector configured to detect light pulses generated by the second device. The light pulses may encode a second device data stored in a memory of the second device. In some implementations, the photodetector is further configured to transduce (or effectuate transduction of) the light pulses into electrical pulses, the electrical pulses decodable by a processor of the second device to recover the second device data. In some embodiments the photodetector is configured to detect light pulses generated by a light-emitting display screen of the second device. In some implementations, one or more of the output pad(s) and the photodetector may operate simultaneously such that first device data is transmitted by the first device while second device data is received by the first device.

In some implementations, the first device may include a light-emitting diode coupled to the processor and configured to emit light during a portion of a timeframe within which one or more of the output pad(s) are being selectively grounded to impose a capacitive load on the capacitive sensor of the second device (i.e. the LED emits light during data transfer).

In some implementations, the first device may include a battery and a solar cell coupled to the battery. The solar cell may be configured to convert light energy into electrical energy that can be stored in the battery.

In some embodiments, one or more of the output pad(s) may impose a capacitive load on the capacitive sensor of the second device without physically contacting the capacitive sensor of the second device. In some instances, the capacitive load imposed by one or more of the output pad(s) on the capacitive sensor of the second device is consistent with the capacitive load imposed by a human finger touching the capacitive sensor. The capacitive sensor in operative communication with the output pad may be embodied in a capacitive touchscreen display of the second device. The second device may include one or more of a smart phone, a tablet, a PDA, and a palmtop.

In still further embodiments, the first device may include: a processor; a memory coupled to the processor and configured to store a first device data; and/or an actuator comprising a pad. In some implementations, the processor is configured to actuate the pad to selectively mimic a tap on a touchscreen of a second device that is positioned such that the pad of the first device is within a sensing distance of a capacitive sensor carried by the touchscreen of the second device. In some embodiments, the first device may include multiple actuators comprising pads, the processor configured to actuate the multiple pads to mimic multiple simultaneous taps on the touchscreen of the second device.

In some implementations, the actuator is configured to be selectively grounded multiple times to mimic multiple taps on the touchscreen of the second device in accordance with a pattern encoding first device data, wherein the pattern is detectable by the second device via the capacitive sensor, and decodable by the second device to recover the first device data.

In some embodiments, the first device may include a photodetector configured to detect one or more light pulses generated by the second device, the one or more light pulses encoding a second device data stored in a memory of the second device. In some implementations, the photodetector further configured to transduce the one or more light pulses into one or more electrical pulses, the one or more electrical pulses decodable by a processor of the second device to recover the second device data. In some embodiments, the actuator and the photodetector may operate simultaneously such that first device data is transmitted by the first device while second device data is received by the first device. In some embodiments, the one or more light pulses are generated by the touchscreen of the second device.

In some embodiments, the first device may include a light-emitting diode coupled to the processor and configured to emit light during a portion of a timeframe within which the pad is selectively mimicking one or more taps on a touchscreen of the second device. In some embodiments, the first device may include a battery and a solar cell coupled to the battery, the solar cell configured to convert light energy into electrical energy that can be stored in the battery.

In some embodiments, the actuator of the first device may mimic a tap on the touchscreen of the second device without physically contacting the capacitive sensor of the second device. In some embodiments, the actuator of the first device may provide a capacitive load on the capacitive sensor of the touchscreen that is consistent with a capacitive load imposed by a human finger touching the capacitive sensor.

Some embodiments of the present technology include a method for communicating data between a first device and a second device. In some implementations, the method may include: positioning an output pad of a first device within a sensing distance of a capacitive sensor of a second device; selectively grounding the output pad of the first device in accordance with a pattern representing a first device data, the selectively grounded output pad thereby imposing a capacitive load on the capacitive sensor of the second device consistent with the pattern representing the first device data; and/or interpreting the pattern at the second device to recover the first device data.

In some implementations, the method may include generating light pulses from a display screen of the second device, the light pulse pattern representing a second device data; detecting the light pulses at the first device via a photodetector at the first device; and/or interpreting the light pulses at the first device to recover the second device data.

In some implementation of the presently disclosed method, the method may include providing a visible indication that the output pad is being selectively grounded by emitting light from a light-emitting diode during and/or between selective grounding instances.

### BRIEF DESCRIPTION OF THE DRAWINGS

FIG. 1 illustrates an example communications environment in accordance with one or more embodiments of the present disclosure.

FIG. 2 illustrates architecture of an exemplary remote device (e.g. first device) in accordance with one or more embodiments of the present disclosure.

FIG. 3 illustrates a flowchart depicting an exemplary method for transmitting data between a remote device (e.g. first device) and a computing device (e.g. second device), in accordance with one or more embodiments of the present disclosure.

FIG. 4 illustrates a flowchart depicting an exemplary method for transmitting data between two separate devices in accordance with one or more embodiments of the present disclosure.

FIG. 5 illustrates an example computing module that may be used to implement various features of the systems and methods for transmitting data between a remote device and a computing device as disclosed herein.

### DETAILED DESCRIPTION

The technology disclosed herein is directed toward transmitting data between multiple devices such as, for example, a remote device and a computing device. In various embodiments, the remote device may receive data from the computing device and/or may transmit data to the computing device.

Data transmission between the remote device and the computing device may use any of a number of wireless communication links such as, for example a radio frequency (RF) link, an optical link, an ultrasonic link, and so on. A radio frequency may include, for example, a low energy communication link such as a radio frequency link based on near field communications (NFC), a Bluetooth low energy (LE) link, a ZigBee link, Wi-Fi, radio-frequency identification (RFID), and/or other radio frequencies.

Data may be transmitted from a data store within the remote device to the computing device without use of a radio frequency. The remote device may transmit the data to the computing device when the computing device is within close proximity of the remote device. As will be discussed in further detail below, conductive matter (e.g., a silicon nub and/or other conductive matter) within the remote device may be used to imitate human touch on the computing device. A visual or audible signal or other indicator may be provided on the remote device (e.g., a blinking light or a beeping sound) to indicate that data is transmitting from the remote device to the computing device. In the case of a visual indicator, for example, a light may blink once or continuously until the transmission is complete.

Consider one example in which the remote device may be a thermostat. A user may wish to use his or her smart phone to retrieve data that was tracked over the last 24 hours by the thermostat (e.g., via an application on the smartphone). The user may place the smartphone within close proximity of the thermostat. A light on the thermostat may blink to indicate that data is transferring to the smartphone. In this way, the user may view temperature fluctuations that were recorded within the last 24 hours, when an air conditioning unit turned on, when the air conditioning unit turned off, and/or various other data tracked by the thermostat within the last 24 hours.

Data may be transmitted from the computing device to the remote device without use of a radio frequency. The remote device may receive the data from the computing device when the computing device is within close proximity of the remote device. As will be discussed in further detail below, in some embodiments light from the computing device may power the remote device and be used to transmit data to the remote device. A light on the remote device may blink to indicate that data is transmitting from the computing device to the remote device. The light may blink once or continuously until the transmission is complete. For example, as discussed above, the remote device may be a thermostat. A user may input specific settings for the thermostat using, for example, a keyboard or graphical user interface of the computing device, which may be associated with a particular application on the computing device. This may allow the user to input at the computing device settings such as, for example, temperature settings for particular times of the day and/or other specific settings for the thermostat. The user may place the smartphone within close proximity of the thermostat. An alert may be provided by the remote device (e.g., a light on the thermostat may blink) to indicate that the thermostat is connected and receiving data from the smartphone. As this example illustrates, in various embodiments the user may input specific settings for the remote device (e.g. the thermostat in this example) using the graphical user interface or other input of the smartphone.

While the above examples described scenarios in which data transfer was unilateral, or one way, between the remote device and the computing device, the data transfer may also be two-way. That is, data may be bilaterally transmitted between the remote device and the computing device without use of a radio frequency. The remote device may receive data from the computing device and may transmit data to the computing device when the computing device is within close proximity of the remote device. Similar to the example described above, a light on the remote device may blink (or other audio, visual or tactile alert may be provided) to indicate that data is being transmitted to the computing device and being received from the computing device. The light may blink once or continuously until the transmission is complete. For example, a toy robot may receive instructions from a smartphone and may transmit collected data to the smartphone in a similar manner as described above. Similarly, in various embodiments, an indication may be provided at the computing device to indicate that the computing device is transmitting or receiving data.

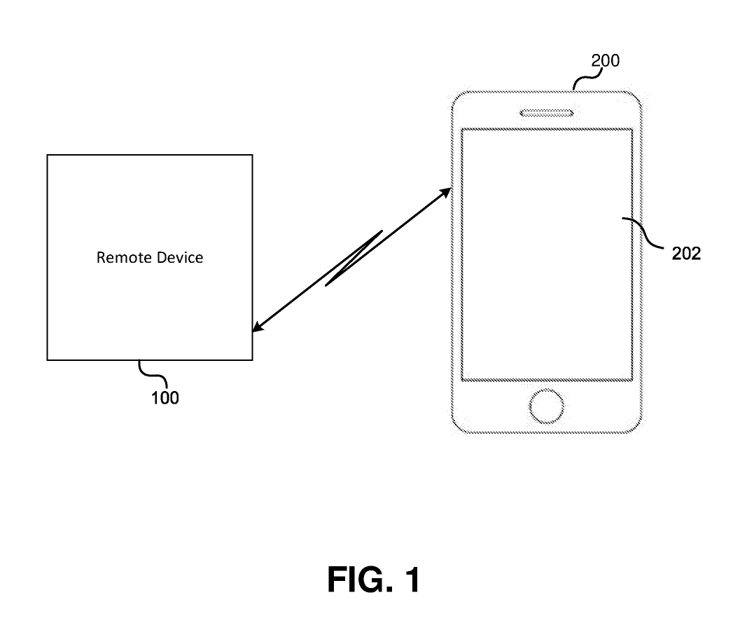

FIG. 1 illustrates an example communications environment in accordance with an exemplary embodiment. As shown in FIG. 1, remote device 100 and computing device 200 may communicate with one another. While two devices are shown in FIG. 1, this is for exemplary purposes only. More than two devices may be provided to communicate with one another. Remote device 100 may include any object and/or product capable of receiving and/or transmitting data (e.g., a washing machine, a coffee machine, a refrigerator, a thermostat, a toy (e.g., a toy car, a toy figurine, and/or any other toy), a gaming console, and/or any other object and/or product). Although a smart phone is illustrated in FIG. 1 as computing device 200, this is for exemplary purposes only, as computing device 200 may include any computing device (e.g., a smartphone, a tablet, a laptop, a smartwatch, a desktop, and/or any other computing device) configured to receive data from remote device 100 and/or transmit data to remote device 100. Computing device 200 may include one or more processors and memory modules for processing and interacting with data received from remote device 100 and/or a user. Computing device 200 may provide a graphical user interface (GUI) displayed on touchscreen 202 to perform functions such as receiving user inputs, displaying data (e.g., information stored within memory associated with computing device 200, information received from remote device 100, information received from the user input, and/or any other information) to the user, and transmitting light to remote device 100.

Computing device 200 may include touchscreen 202. Touchscreen 202 may include any type of touchscreen including, for example, resistive, surface capacitive, projected capacitive, SAW (Surface Acoustic Wave), and infrared. A capacitive touchscreen, for example, may include one or more capacitive sensors (not shown). Touchscreen 202 may receive an input in the form of pressing or touching by a human (e.g., a finger tap), a stylus, or other instrumentality. Such touchscreen interactions may be used to operate GUI buttons, sliders, links, and so on, via touchscreen 202. The touchscreen (e.g., via sensors such as resistive, capacitive) may detect conductive matter, such as a human finger, a stylus, a silicon nub, and/or any other conductive matter. The sensors may respond to conductive material within close proximity of the capacitive sensors (e.g., a silicon nub, not shown, associated with remote device 100). The touchscreen sensors (e.g., capacitive sensors) may not require application of force or physical touch to its surface to respond to the conductive material. As such, touchscreen 202 may not require application of force to its surface. Capacitance may be based upon a surface area of the conductive material (e.g., human body, stylus, etc.). Touchscreen 202 may receive a “tap” from the silicon nub (or other conductive matter included within remote device 100) as an input.

Remote device 100 may include circuitry. Circuitry may include components used to perform the features and functions described herein including, for example a microcontroller and/or other processing system (e.g., having one or more processors or processor cores and suitable memory) programmed or otherwise configured to perform the functions of the remote device, and other functions as would be apparent to one of ordinary skill in the art upon reading this description.

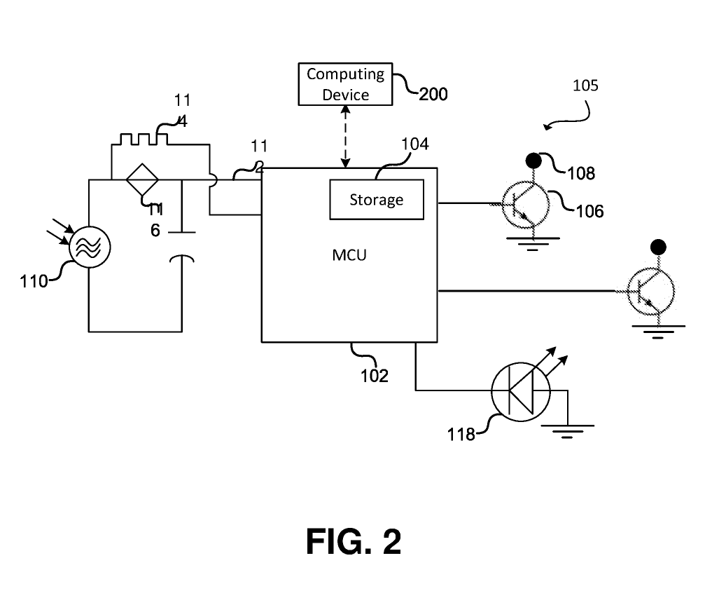

FIG. 2 is a diagram illustrating an example architecture for such circuitry in accordance with one embodiment of the technology disclosed herein. In this example, circuitry of remote device 100 may include processing module 102. Processing module 102 may include a one or more IC microcontrollers (MCU), ASICs, FPGAs, a processor system using one or more single or multi-core processors, and/or other processing modules.

Processing module 102 may also include storage 104. Storage 104 may include memory such as, for example, volatile memory (e.g. RAM), non-volatile memory (e.g. flash storage or ROM), and/or any other storage device and/or some combination thereof. Storage 104 may store instructions and provide memory for processing module 102. Storage 104 may also store data obtained and/or tracked by remote device 100, data received from computing device 200, and/or other data received by remote device 100. For example, a coffee machine (e.g., remote device 100) may receive instructions from a user to brew a pot of coffee every weekday morning at 7 AM. The coffee machine may receive instructions from the user to brew a pot of coffee on a weekend morning at 10 AM. The instructions and/or inputs received by the coffee machine may be stored within storage 104 of processing module 102. As a further example, the coffee machine may store data as to the number of pots brewed, brewing cycles used, temperature of the water use to brew the coffee, the times at which coffee is dispensed from the machine, the amounts of coffee dispensed, types of coffee selected, and so on.

Remote device 100 may transmit data from storage 104 to computing device 200. Continuing with the example of a coffee machine, the machine may send one or more elements of the stored information regarding coffee dispensing and/or brewing to computing device 200 in the illustrated example, processing module 102 may output to a transmitter such as, for example, LED 118 or an actuator, 105. As shown in FIG. 2, the circuitry may include one or more transistors. The circuitry may also include one or more LEDs. For purposes of this example, transistor 106 is shown external to processing module 102, but one of ordinary skill in the art may appreciate that transistor 106 may be included within processing module 102. Transistor 106 may be turned on by the circuitry to capacitively load pad 108 for a determined time, or in a determined time pattern. One or more pads 108 may be included (or a pad may be divided into multiple areas) and each pad (or pad area) may be selectively grounded, as shown in FIG. 2. Grounding pad 108 may mimic and/or imitate a human body capacitance for touchscreen 202 of computing device 200. Pad or pads 108 may be placed in direct contact with touchscreen 202 of computing device 200. Alternatively, pad or pads 108 may placed be within close proximity (e.g., within a sensing field) of computing device 200 without direct contact with touchscreen 202. For example, pads 108 may be in close enough proximity to touchscreen 202 to mimic and/or imitate touch by a human body when one or more pads 108, or areas of pad 108, are be grounded by the circuitry. In this manner, touchscreen 202 may receive capacitive loading similar to that of human touch via grounded pads 108, such that pad or pads 108 mimic human touch on touchscreen 202, thereby transferring data from remote device 100 to computing device 200. Computing device 200 may receive one or more “taps” from the processing module 102 by selectively grounding one or more pads 108 at a single point or numerous points. Numerous “taps” may increase the data rate for parallel communication streams based upon the number of simultaneous “taps”. For example, conventional smart phones are configured to accept a maximum of 4 simultaneous “taps”, while conventional tablets may accept a maximum of 10 simultaneous “taps”. However, any number of pads 108 can be provided to mimic a desired number of simultaneous taps or to allow taps on different parts of touchscreen 202 without having to reposition remote device 100 during the communication event.

One of the “taps” may be a clock to clock the data. Consider an example in which a refrigerator may obtain data about a power outage. The refrigerator may determine and store a time when power was lost to the refrigerator, the temperature within the refrigerator during the outage, any time at which power was reestablished to the refrigerator. Such data may be transmitted from processing module 102 via grounded pad 108 within the refrigerator to computing device 200 through one or more points (e.g., one tap or multiple simultaneous “taps” on touchscreen 202 via grounded pad(s) 108), such that computing device 200 can receive the data via the GUI for processing and/or display to the user via the GUI.

As indicated above, remote device 100 may also receive data from computing device 200. For example, in one embodiment, light from a display screen of computing device 200 may be modulated to form an optical data stream that may be optically transmitted to remote device 100 for communication purposes. Further to this example, an optical detector or photodetector such as photocell 110 may be provided to receive this light from computing device 200. Photocell 110 may convert the detected light into electromagnetic signals in response to the amplitude and duration of the light pulses. The signals from photocell 110 may be output in the form of a datastream 114 that may be sent to processing module. Full bridge rectifier 116 may be included to provide a relatively constant voltage supply to processing module 102.

For example, consider a scenario in which a remote device 100 is mounted on a piece of machinery (e.g., a washing machine in a home, a fabrication machine in a factory, or other machinery) to receive input from a user in operation of the machine. Computing device 200 in such a scenario may include, for example, a smart phone or tablet configured to accept user input in operation of the machine. An application with a keypad, touchscreen display, or other GUI may be provided on computing device 200 to allow the user to enter in the operational parameters for the machine. For example, the display or GUI can be configured in the layout of a dashboard or control panel for the machine to be controlled.

In this scenario, the user inputs commands and/or other control parameters into computing device 200 to effectively program or direct the operation of the machine. For example, in the case of a washing machine, the user inputs may include user specific settings to run various cycles on the washing machine (e.g., cold water, permanent press, cycle times, spin speeds, etc.). Computing device 200 may be placed within communication range of the remote device 100 on the washing machine. The display screen of computing device 200 may output pulses or patterns of light and the machine may receive light from computing device 200 (e.g., via photocell 110.) The light may be modulated to send data and/or other information (e.g., the commands to run the machine) to remote device 100. The photo detector at remote device 100 (e.g., photocell 110) detects a light and converts it into a pulse train of data 114 to send to processing module 102. In such a scenario, user inputs from computing device 200 may be received by the machine and used to program the operation of the machine. The user specific settings may be stored within storage 104. The machine may run a cycle with the user specific settings received from computing device 200. During or after operation, the machine may relay information back to computing device 200 via pad 108. Data gathered during operation of the machine and/or other data from the machine may be transmitted to the computing device 200. In accordance with the example of FIG. 2, this can be via optical communication or by simulating touches on the touchscreen. This can be accomplished, for example, by capacitively loading one or more pads 108, areas of pad 108, in an on-off fashion to imitate taps on the touchscreen of computing device 200, thereby transferring the data. This may allow the user interface provided on the machine itself to be quite simple or minimalistic without requiring a complicated user interface for the machine.

As the above example illustrates, transmitting data between remote device 100 and computing device 200 may be bidirectional. Remote device 100 may receive data from computing device 200 and transmit data to computing device 200. As another example, remote device 100 may include a toy car. The toy car may receive user inputs from computing device 200. The toy car may obtain data while traveling including distance traveled, directions traveled, and/or any other data associated with the toy car. The toy car may transmit the obtained data to computing device 200 when computing device 200 may be placed within a sensing field of the toy car.

In some embodiments, computing device 200 can be held in proximity to remote device 100 by the user. In other embodiments a cradle or other mounting structure can be provided such that the user can position computing device 200 in the mounting structure to be held by remote device 100.

As one having skill in the art would appreciate from the above description, although optical or RF communication interfaces can also be provided, remote device 100 and computing device 200 may communicate without use of a radio frequency. Remote device 100 may transmit data to computing device 200 and/or may receive data from computing device 200 without use of a radio frequency.

Remote device 100 may also include solar cells for generating electrical power from light received by those cells such as, for example, photovoltaic cells. The solar cells may convert optical energy into, for example, a DC voltage, which may further be inverted to provide AC power. In one embodiment, these solar cells may be positioned such that they receive light from the screen of computing device 200 when remote device 100 is placed within proximity of computing device 200. As such, a separate power source may not be required to operate remote device 100, or at least the communication circuitry of remote device 100. Solar cells may also be provided on other surfaces of remote device 100 to collect light for purposes of generating power. A battery may also be included to store energy when light sources are available such that energy that may be used to power the device in the solar cells are not generating electricity.

In yet another application scenario, remote device 100 may be used in a gaming context. For example, a plurality of different gaming figures or figurines may be provided as one or more remote devices 100 and personalized identities stored within the one or more remote devices 100. In this scenario, a computing device 200 may be programmed to include an interface (e.g., touchscreen 202) to accept information from one or more pads 108 of the one or more remote devices 100 on each figure. Computing device 200 may be the device on which the game is run, or it may interface to a gaming console via a communications interface. In this scenario, information from one or more figures may be transferred via one or more pads 108 on each figure to the videogame. In this manner, identification of the figure as well as its characteristics may be transferred to and used by the game for gameplay. Characteristics of the figure may include, for example, things such as the number of lives the figure has, weapons the figure has collected, capabilities the figure possesses, credits the figure has earned, and so on.

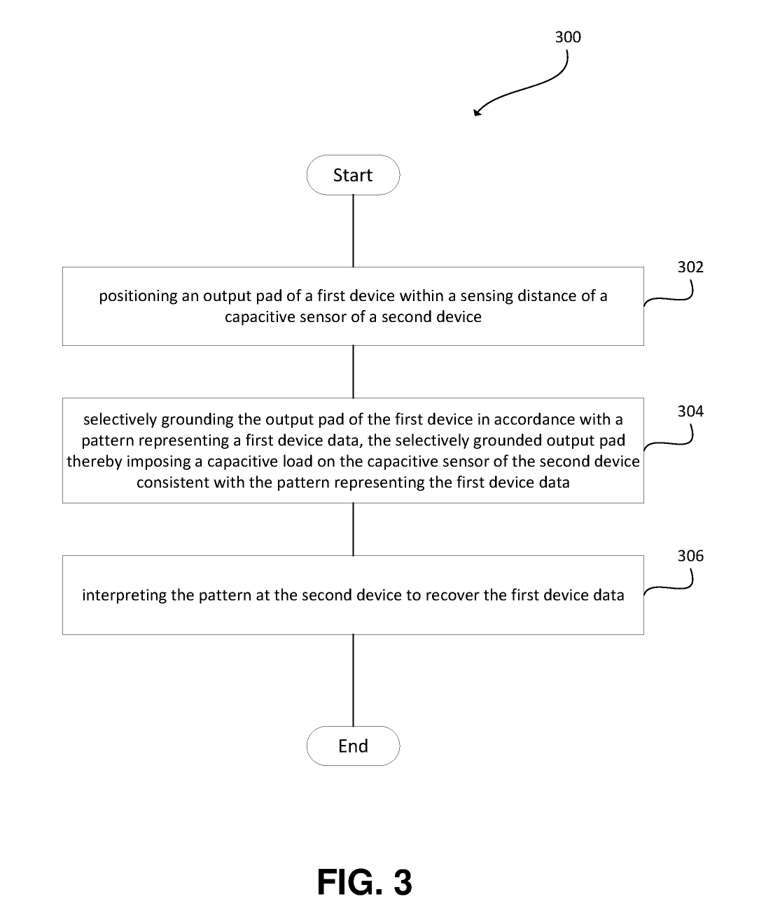

FIG. 3 illustrates a flowchart depicting an exemplary method for transmitting data between a remote device (e.g. first device) and a computing device (e.g. second device), in accordance with one embodiment of the present disclosure. As shown, at operation 302, method 300 may include positioning an output pad (e.g., groundable pad 108) of a first device within a sensing distance of a sensor of a second device (e.g., touchscreen 202). At operation 304, method 300 may include selectively grounding the output pad, or areas of the output pad, of the first device in accordance with a pattern representing a first device data, the selectively grounded output pad thereby imposing a capacitive load on the capacitive sensor of the second device consistent with the pattern representing the first device data. Selectively grounding the output pad may include turning a transistor on and off using a processor operatively coupled therewith, as explained herein. At operation 306, method 300 may include interpreting the pattern at the second device to recover the first device data.

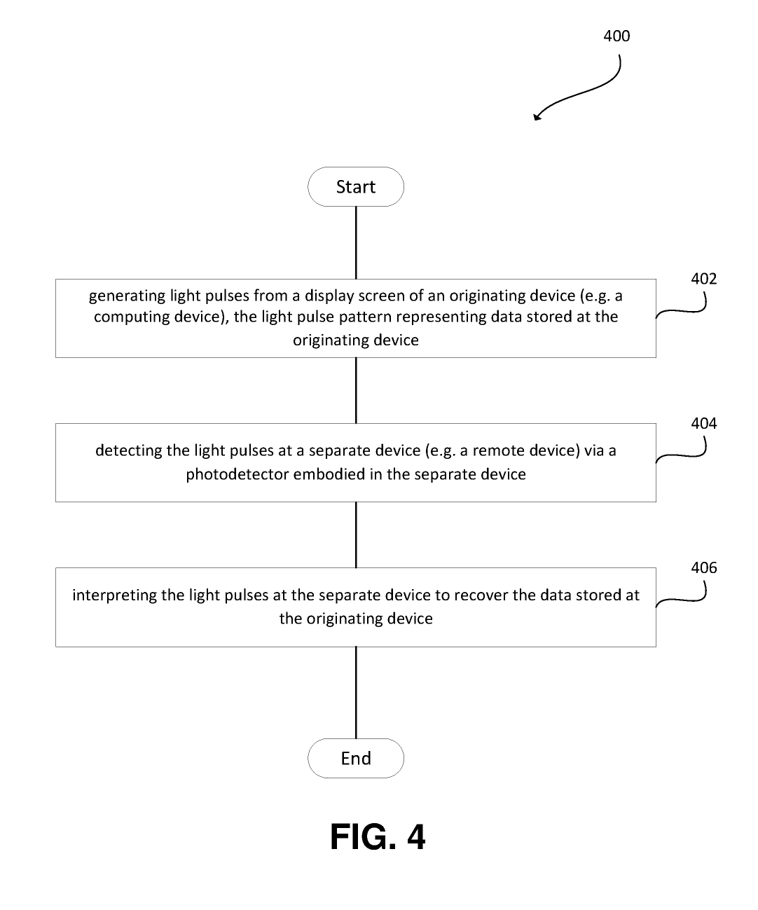

FIG. 4 illustrates a flowchart depicting an exemplary method for transmitting data between two separate devices in accordance with one or more embodiments of the present disclosure. As shown, at operation 402, method 400 may include generating light pulses from a display screen of an originating device (e.g. a computing device), the light pulse pattern representing data stored at the originating device. As shown, at operation 404, method 400 may include detecting the light pulses at a separate device (e.g. a remote device) via a photodetector embodied in the separate device. As shown, at operation 406, method 400 may include interpreting the light pulses at the separate device to recover the data stored at the originating device.

As described herein, method 300 and/or method 400 may be implemented simultaneously and/or separately, in accordance with one or more embodiments of the present disclosure.

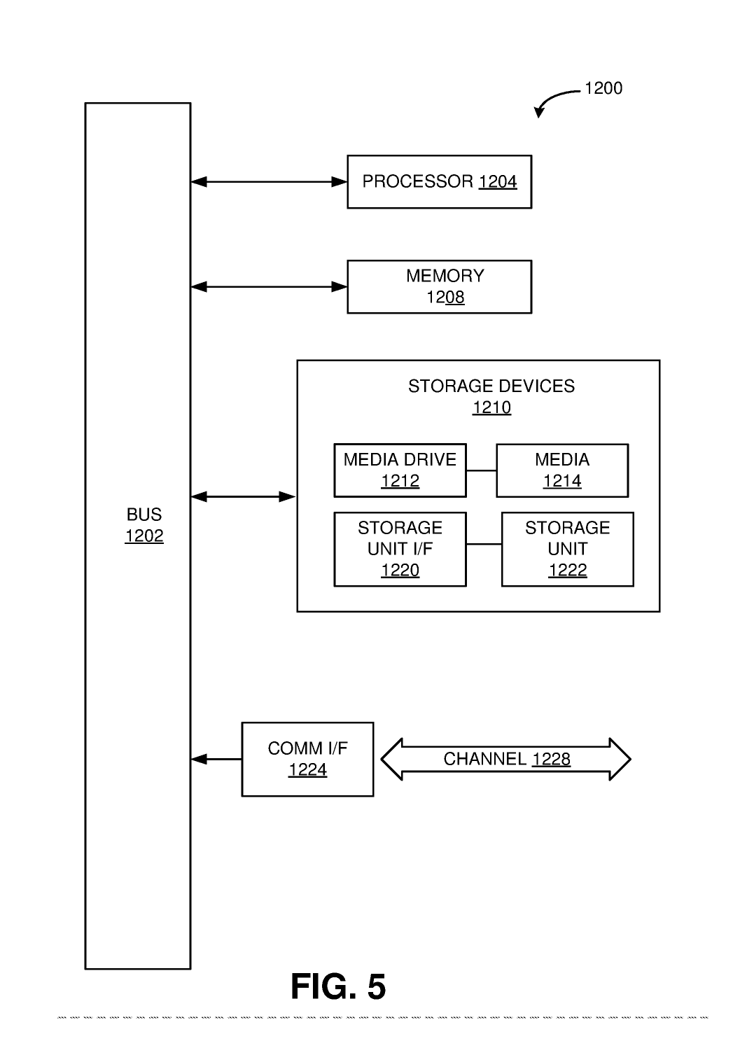

FIG. 5 illustrates an example computing module that may be used to implement various features of the systems and methods for transmitting data between a remote device and a computing device as disclosed herein. As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 5. Various embodiments are described in terms of this example—computing module 1200. After reading this description, it will become apparent to a person skilled in the relevant art how to implement the application using other computing modules or architectures.

Referring now to FIG. 5, computing module 1200 may represent, for example, computing or processing capabilities found within desktop, laptop, notebook, and tablet computers; hand-held computing devices (tablets, PDA's, smart phones, cell phones, palmtops, etc.); wearable computing devices such as smartwatches; mainframes, supercomputers, workstations or servers; or any other type of special-purpose or general-purpose computing devices as may be desirable or appropriate for a given application or environment. Computing module 1200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1200 might include, for example, one or more processors, controllers, control modules, or other processing devices, such as a processor 1204. Processor 1204 might be implemented using a general-purpose or special-purpose processing engine such as, for example, a microprocessor, controller, or other control logic. In the illustrated example, processor 1204 is connected to a bus 1202, although any communication medium can be used to facilitate interaction with other components of computing module 1200 or to communicate externally.

Computing module 1200 might also include one or more memory modules, simply referred to herein as main memory 1208. For example, preferably random access memory (RAM) or other dynamic memory, might be used for storing information and instructions to be executed by processor 1204. Main memory 1208 might also be used for storing temporary variables or other intermediate information during execution of instructions to be executed by processor 1204. Computing module 1200 might likewise include a read only memory (“ROM”) or other static storage device coupled to bus 1202 for storing static information and instructions for processor 1204.

The computing module 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a solid state drive, a magnetic tape drive, an optical disk drive, a CD, DVD, or Blu-ray drive (R or RW), or other removable or fixed media drive might be provided. Accordingly, storage media 1214 might include, for example, a hard disk, a solid state drive, magnetic tape, cartridge, optical disk, a CD, DVD, Blu-ray or other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing module 1200. Such instrumentalities might include, for example, a fixed or removable storage unit 1222 and an interface 1220. Examples of such storage units 1222 and interfaces 1220 can include a program cartridge and cartridge interface, a removable memory (for example, a flash memory or other removable memory module) and memory slot, a PCMCIA slot and card, and other fixed or removable storage units 1222 and interfaces 1220 that allow software and data to be transferred from the storage unit 1222 to computing module 1200.

Computing module 1200 might also include a communications interface 1224. Communications interface 1224 might be used to allow software and data to be transferred between computing module 1200 and external devices. Examples of communications interface 1224 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1224 might typically be carried on signals, which can be electronic, electromagnetic (which includes optical) or other signals capable of being exchanged by a given communications interface 1224. These signals might be provided to communications interface 1224 via a channel 1228. This channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1208, storage unit 1220, media 1214, and channel 1228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1200 to perform features or functions of the present application as discussed herein.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

We claim:

1. A first device configured to communicate with a second device, the first device comprising:
a processor;
a memory coupled to the processor and configured to store a first device data;
a transistor having a base coupled to the processor, an emitter coupled to ground, and a carrier coupled to an output pad;
wherein the processor is configured to cause the transistor to selectively ground the output pad, the grounded output pad configured to impose a capacitive load on a capacitive sensor of a second device when brought within a sensing distance of the capacitive sensor;
wherein the output pad is configured to be selectively grounded multiple times to impose a capacitive load on the capacitive sensor of the second device in accordance with a pattern, the capacitive load pattern encoding the first device data; and
wherein the pattern is detectable by the second device via the capacitive sensor, and decodable by the second device to recover the first device data.

2. The first device of claim 1, further comprising:
a photodetector configured to detect light pulses generated by the second device, the light pulses encoding a second device data stored in a memory of the second device;
wherein the photodetector is further configured to transduce the light pulses into electrical pulses, the electrical pulses decodable by a processor of the second device to recover the second device data.

3. The first device of claim 1, further comprising:
a light-emitting diode coupled to the processor and configured to emit light during a portion of a timeframe within which the output pad is being selectively grounded to impose a capacitive load on the capacitive sensor of the second device.

4. The first device of claim 1, further comprising:
a battery;
a solar cell coupled to the battery, the solar cell configured to convert light energy into electrical energy that can be stored in the battery.

5. The first device of claim 1, wherein the output pad may impose a capacitive load on the capacitive sensor of the second device without physically contacting the capacitive sensor of the second device.

6. The first device of claim 1, wherein the capacitive load imposed by the output pad on the capacitive sensor of the second device is consistent with the capacitive load imposed by a human finger touching the capacitive sensor.

7. The first device of claim 1, wherein the capacitive sensor is embodied in a capacitive touchscreen display of the second device, the second device including one or more of a smart phone, a tablet, a PDA, and a palmtop.

8. The first device of claim 1, wherein the capacitive load pattern is a temporal pattern.

9. The first device of claim 2, wherein the photodetector is configured to detect light pulses generated by a light-emitting display screen of the second device.

10. The first device of claim 2, wherein the output pad and the photodetector may operate simultaneously such that first device data is transmitted by the first device while second device data is received by the first device.

11. A first device configured to communicate with a second device, the first device comprising:
a processor;
a memory coupled to the processor and configured to store a first device data;
two or more transistor(s);
two or more output pad(s) operatively coupled with the two or more transistor(s);
wherein the processor is configured to cause the two or more transistor(s) to selectively ground two or more of the output pad(s), the grounded output pad(s) configured to impose a capacitive load on a capacitive sensor of a second device when brought within a sensing distance of the capacitive sensor;
wherein the two or more output pad(s) are configured to be selectively grounded to impose a capacitive load pattern on the capacitive sensor of the second device, the capacitive load pattern encoding the first device data; and
wherein the capacitive load pattern is detectable by the second device via the capacitive sensor, and decodable by the second device to recover the first device data.

12. The first device of claim 10, wherein two or more output pad(s) are configured to impose a capacitive load at different locations on the capacitive sensor of the second device;

13. The first device of claim 11, further comprising:
a photodetector configured to detect light pulses generated by the second device, the light pulses encoding a second device data stored in a memory of the second device;
wherein the photodetector is further configured to transduce the light pulses into electrical pulses, the electrical pulses decodable by a processor of the second device to recover the second device data.

14. The first device of claim 11, further comprising:
a light-emitting diode coupled to the processor and configured to emit light during a portion of a timeframe within which one or more output pad(s) are being selectively grounded to impose a capacitive load on the capacitive sensor of the second device.

15. The first device of claim 11, further comprising:
a battery;
a solar cell coupled to the battery, the solar cell configured to convert light energy into electrical energy that can be stored in the battery.

16. The first device of claim 11, wherein one or more of the output pad(s) may impose a capacitive load on the capacitive sensor of the second device without physically contacting the capacitive sensor of the second device.

17. The first device of claim 11, wherein the capacitive load imposed by one or more of the output pad(s) on the capacitive sensor of the second device is consistent with the capacitive load imposed by a human finger touching the capacitive sensor.

18. The first device of claim 11, wherein the capacitive sensor is embodied in a capacitive touchscreen display of the second device, the second device including one or more of a smart phone, a tablet, a PDA, and a palmtop.

19. The first device of claim 11, wherein the capacitive load pattern is a temporal pattern.

20. The first device of claim 12, wherein the capacitive load pattern is a spatial pattern.

21. The first device of claim 12, wherein the capacitive load pattern is a spatiotemporal pattern.

22. The first device of claim 13, wherein the photodetector is configured to detect light pulses generated by a light-emitting display screen of the second device.

23. The first device of claim 13, wherein one or more of the output pad(s) may operate simultaneously with the photodetector such that first device data is transmitted by the first device while second device data is received by the first device.

24. A method for communicating data between a first device and a second device, the method comprising:
positioning an output pad of a first device within a sensing distance of a capacitive sensor of a second device;
selectively grounding the output pad of the first device in accordance with a pattern representing a first device data, the selectively grounded output pad thereby imposing a capacitive load on the capacitive sensor of the second device consistent with the pattern representing the first device data;
interpreting the pattern at the second device to recover the first device data.

25. The method of claim 24, further comprising:
generating light pulses from a display screen of the second device, the light pulse pattern representing a second device data;
detecting the light pulses at the first device via a photodetector at the first device;
interpreting the light pulses at the first device to recover the second device data;

26. The method claim 25, further comprising:
providing a visible indication that the output pad is being selectively grounded by emitting light from a light-emitting diode during and/or between selective grounding instances.

27. A first device configured to communicate with a second device, the first device comprising:
a processor;
a memory coupled to the processor and configured to store a first device data;
an actuator comprising a pad;
wherein the processor is configured to actuate the pad to selectively mimic a tap on a touchscreen of a second device that is positioned such that the pad of the first device is within a sensing distance of a capacitive sensor carried by the touchscreen of the second device.

28. The first device of claim 27, further comprising multiple actuators comprising pads, the processor configured to actuate the multiple pads to mimic multiple simultaneous taps on the touchscreen of the second device.

29. The first device of claim 27, wherein the actuator is configured to be selectively grounded multiple times to mimic multiple taps on the touchscreen of the second device in accordance with a pattern encoding first device data, wherein the pattern is detectable by the second device via the capacitive sensor, and decodable by the second device to recover the first device data.

30. The first device of claim 27, further comprising:
a photodetector configured to detect one or more light pulses generated by the second device, the one or more light pulses encoding a second device data stored in a memory of the second device;
wherein the photodetector is further configured to transduce the one or more light pulses into one or more electrical pulses, the one or more electrical pulses decodable by a processor of the second device to recover the second device data.

31. The first device of claim 27, further comprising:
a light-emitting diode coupled to the processor and configured to emit light during a portion of a timeframe within which the pad is selectively mimicking one or more taps on a touchscreen of the second device.

32. The first device of claim 27, further comprising:
a battery;
a solar cell coupled to the battery, the solar cell configured to convert light energy into electrical energy that can be stored in the battery.

33. The first device of claim 27, wherein the actuator may mimic a tap on the touchscreen of the second device without physically contacting the capacitive sensor of the second device.

34. The first device of claim 27, wherein actuator is configured to provide a capacitive load on the capacitive sensor of the touchscreen that is consistent with a capacitive load imposed by a human finger touching the capacitive sensor.

35. The first device of claim 27, wherein the second device includes one or more of a smart phone, a tablet, a PDA, and a palmtop.

36. The first device of claim 29, wherein the pattern is a temporal pattern.

37. The first device of claim 30, wherein the one or more light pulses are generated by the touchscreen of the second device.

38. The first device of claim 30, wherein the actuator and the photodetector may operate simultaneously such that first device data is transmitted by the first device while second device data is received by the first device.
